(19) United States
(12) Patent Application Publication
(10) Pub. No.: US 2011/0311343 A1
(43) Pub. Date: Dec. 22, 2011

(54) WORK EDGE DETECTION MECHANISM AND WORK TRANSFERRING MECHANISM

(75) Inventors: Toshimitsu SHIRAISHI, Kamisato (JP); Noritake SHIZAWA, Kamisato (JP); Takashi TARUMITSU, Kamisato (JP); Shinjiro ISHII, Kamisato (JP); Hisayuki TAGOMORI, Kamisato (JP)

(73) Assignee: HITACHI HIGH-TECHNOLOGIES CORPORATION, Tokyo (JP)

(21) Appl. No.: 13/163,858

(22) Filed: Jun. 20, 2011

(30) Foreign Application Priority Data
Jun. 22, 2010 (JP) 2010-141308

(51) Int. Cl. B65G 47/91; G01B 11/14; B25J 15/06

(52) U.S. Cl. 414/752.1; 356/615; 901/40

(57) ABSTRACT

This invention relates to a work edge detection mechanism that enables an edge of a work to be viewed clearly through an aligning camera without adding an illumination device, and to a work transfer mechanism that uses the work edge detection mechanism. The work edge detection mechanism formed from a tubular body provided with an opening at one end thereof, the tubular body having a blocking member provided at the other end thereof, includes light-reflecting means on a lower surface side of the blocking member in order to reflect any light entering from the opening, is constructed so that the tubular body has an inside diameter (φ1) at the opening of the tubular body and an inside diameter (φ2) at a side of the blocking member, the inside diameter (φ2) being greater than the inside diameter (φ1), and enables vacuum suction transfer of the work.

### BACKGROUND

The present invention relates generally to work edge detection mechanisms and to work transfer mechanisms using the same. More particularly, the invention is directed to a work transfer mechanism that includes a work edge detection mechanism designed so that when the transfer mechanism uses vacuum suction to hold an edge of a work and transfer the work, the detection mechanism can detect accurately and easily the work edge to be held by vacuum suction.

A magnetic disk, optical disk, nano-imprint disk, or other disk-shaped substrates (hereinafter, referred to simply and collectively as disks) have a through-hole of a predetermined inside diameter centrally of the disk. Such disks are transferred or subjected to film deposition and nano-imprinting through various processes. Vacuum suction transfer mechanisms that hold and handle the disks have been traditionally used for these processes. Such vacuum suction transfer mechanisms are described in, for example, Japanese Patent Application Publication Nos. JP-A-1994-68526 and JP-A-1995-215461.

An example of a conventional vacuum suction transfer mechanism of this kind is shown in FIG. 10. This conventional vacuum suction transfer mechanism 100 brings a vacuum chuck 106 into contact with a non-recording region 104 present near an inner edge of a recording region 102 on a disk 101, then uses a vacuum pressure to attract the disk 101 via a suction pipe 110 connected to a suction head 108, and transfers the disk 101 in the vacuum-held condition on the suction head 108. The vacuum chuck 106 has a suction hole 112 extending from a lower surface of the chuck to an upper surface thereof, with an upper end of the suction hole 112 communicating with exhaust spaces 114 in the suction head 108, and with the suction pipe 110 being connected to one end of each exhaust space 114. Air that has been drawn in from the suction hole 112 flows in a direction marked with an arrow. Reference number 116 in the figure denotes a robot hand that moves the suction head 108 in XYZ directions.

FIG. 11 is a partly enlarged view of FIG. 10. When the vacuum chuck 106 is made to attract the disk 101 by suction, the vacuum chuck 106 needs to be positioned in the non-recording region 104 in order to prevent the vacuum chuck 106 from coming into contact with the recording region 102 and damaging or fouling the recording region 102. For a disk of 64 mm or less in diameter, the non-recording region 104 is about 2 mm wide or not more than about 3 mm wide. The disk 101 has its central position to which the vacuum chuck 106 will be positioned and the positioning is generally performed by calculating the central position by image processing. In addition, the disk 101 is generally chamfered at both upper and lower edge portions of an inner circumferential surface formed by its central through-hole. The chamfers 120 are provided to prevent nicks, cracks, and other forms of damage from occurring at an inner circumferential end face of the central through-hole. The inner circumferential vertical wall surface (edge) 122 of the disk may have a marking for central position detection in order to facilitate positioning of the vacuum chuck 106 by an aligning camera 118. The marking is provided in a plurality of places (e.g., four places) at mutually opposing positions. In a case where the marking is provided in four places, therefore, the aligning camera 118 is moved to detect the positions of the four markings in order. The markings can each be, for example, a color-coated section, a mechanical notch, or the like.

The aligning camera 118 uses illumination to detect the disk edge 122. However, this detection method has had a problem in that when the disk edge 122 is viewed through the aligning camera 118 in order to calculate the central position of the disk by image processing with the camera 118, since the inner circumferential surface formed by the central through-hole are chamfered at the upper and lower edge portions, relative contrast with respect to the background decreases and the disk edge 122 becomes difficult to discriminate from the chamfers 120. Such a problem has led to consumption of an unnecessary time during disk center positioning, thus deteriorating total working efficiency.

Although a way to add illumination at an opposite side of the disk can instead be used for improved relative contrast with respect to the background, the vacuum chuck 106 does not have an enough space to accommodate an illumination device in an internal cavity 124 of the vacuum chuck 106 itself.

In a case where, as shown in FIG. 12, the work 130 has a chamfered outer circumferential edge, inclusive of the disk 101, the work can be transferred while the work is securely held from the left and right thereof with chuck members 134 of a transfer mechanism 132, after the outer circumferential vertical wall edge 122 is viewed through use of the aligning camera 118 and image processing is conducted for edge and/or center truing of the work. The chuck members 134 are constructed so as to be capable of being brought close to and opposed away from each other along an arm 136. Even with the transfer mechanism 132 as mentioned above, however, as described for the disk 101, the outer circumferential edge 122 of the disk that have the chamfers 120 has been difficult to be detected through the aligning camera 118, because of the low contrast of the camera image with respect to the background. If the illumination device for illuminating the opposite side of the work is disposed in the transfer mechanism 132 itself in order to enhance image contrast with respect to the background, this will be unrealistic since the work varies in size.

### SUMMARY

An object of the present invention is therefore to provide a work edge detection mechanism that can clearly detect an edge of a work through an aligning camera without adding an illumination device.

Another object of the present invention is to provide a work transfer mechanism including the work edge detection mechanism described above, the work transfer mechanism being based upon vacuum suction.

After studies by the present inventors, the foregoing problems can be solved by employing a work edge detection mechanism formed from a tubular body provided with an opening at one end thereof, the tubular body having a blocking member provided at the other end thereof, the work edge detection mechanism further including, on a lower surface side of the blocking member, means for reflecting any light entering from the opening.

Such incident illumination light from an aligning camera or the like entered from the opening side of the tubular body is reflected by the surface of the light-reflecting means, for example a mirror. This results in contrast being enhanced relative to a background and thus enables a work edge 122 to be definitely discriminated from chamfers 120 of the disk already chamfered at its edge portions.

The foregoing problems can likewise be solved by employing another work edge detection mechanism formed from a tubular body provided with an opening at one end thereof, the tubular body having a blocking member provided at the other end thereof, wherein the tubular body has an inside diameter (φ1) at the opening of the tubular body and an inside diameter (φ2) at a side of the blocking member, the inside diameter (φ2) being greater than the inside diameter (φ1).

Making the inside diameter on the blocking member side opposite to the opening of the tubular body increase above the inside diameter on the opening side of the tubular body, the incident illumination light from an aligning camera or the like entered from the opening side of the tubular body will be reflected by the surface of the blocking member greater in inside diameter (i.e., greater in surface area), resulting in increase in the amount of light reflected. This will enhance relative contrast with respect to the background, making the detection mechanism discriminate the work edge 122 definitely from the chamfers 120 of the disk having the chamfered edge.

The foregoing problems can likewise be solved by using yet another work edge detection mechanism formed from a tubular body provided with an opening at one end thereof, the tubular body having a blocking member provided at the other end thereof, the work edge detection mechanism being provided with, on a lower surface side of the blocking member, means for reflecting any light entering from the opening, wherein the tubular body has an inside diameter (φ1) at the opening of the tubular body and an inside diameter (φ2) at a side of the blocking member, the inside diameter (φ2) being greater than the inside diameter (φ1).

The light-reflecting means (e.g., a mirror surface) and the increased reflecting surface area will further increase the amount of light reflected, and hence, synergistically enhance relative contrast with respect to the background. This will make the detection mechanism discriminate the work edge 122 even more definitely from the chamfers 120 of the disk having the chamfered edge.

The foregoing problems can likewise be solved by employing a work transfer mechanism that uses vacuum suction means to transfer a work; wherein the vacuum suction means includes a vacuum suction chuck, a vacuum suction head coupled to the vacuum suction chuck, and a robot hand connected to the head in order to move the head in XYZ directions, and wherein the vacuum suction chuck includes an annular sidewall and an internal cavity surrounded by the sidewall; the sidewall internally containing an air suction hole that extends from a lower end to an upper end thereof, the lower end of the air suction hole being opened towards the atmosphere, the upper end of the air suction hole being opened towards an internal exhaust space of the vacuum suction head, a member for blocking the internal cavity being disposed at an upper end of the cavity, and means for reflecting light being disposed on a lower surface side of the blocking member.

Illumination light from an aligning camera or the like entered from the opening that is located lower end of the annular sidewall is reflected by the surface of the light-reflecting means (e.g., a mirror). This reflection enhances relative contrast with respect to the background, leading to definite discrimination of the work edge 122 from chamfers 120 of the disk having the chamfered edge. Rapid disposition of the vacuum suction chuck at a predetermined position on the disk is therefore achieved.

The foregoing problems can likewise be solved by employing another work transfer mechanism that uses vacuum suction means to transfer a work; wherein the vacuum suction means includes a vacuum suction chuck, a vacuum suction head coupled to the vacuum suction chuck, and a robot hand connected to the head in order to move the head in XYZ directions, and wherein the vacuum suction chuck includes an annular sidewall and an internal cavity surrounded by the sidewall; the sidewall internally containing an air suction hole that extends from a lower end to an upper end thereof, the lower end of the air suction hole being opened towards the atmosphere, the upper end of the air suction hole being opened towards an internal exhaust space of the vacuum suction head, the internal cavity being blocked at its upper end, and the upper end of the internal cavity having an inside diameter φ2 greater than an inside diameter φ1 of a lower end of the cavity.

Even without light-reflecting means or any other special member being disposed at the upper end of the internal cavity, increasing the inside diameter of the internal cavity upper end above that of the lower end will increase the amount of light reflected, since any illumination light from an aligning camera or the like entered from the opening that is located lower end of the annular sidewall will reflect on the surface of the blocking member having the greater inside diameter (i.e., having a greater surface area). The increase in the amount of reflection will enhance relative contrast with respect to the background, leading to definite discrimination of the work edge 122 from chamfers 120 of the disk having the chamfered edge. Rapid disposition of the vacuum suction chuck at a predetermined position on the disk will therefore be achieved.

The foregoing problems can likewise be solved by employing yet another work transfer mechanism that uses vacuum suction means to transfer a work; wherein the vacuum suction means includes a vacuum suction chuck, a vacuum suction head coupled to the vacuum suction chuck, and a robot hand connected to the head in order to move the head in XYZ directions, and wherein the vacuum suction chuck includes an annular sidewall and an internal cavity surrounded by the sidewall; the sidewall internally containing an air suction hole that extends from a lower end to an upper end thereof, the lower end of the air suction hole being opened towards the atmosphere, the upper end of the air suction hole being opened towards an internal exhaust space of the vacuum suction head, a member for blocking the internal cavity being disposed at an upper end of the cavity, means for reflecting light being disposed on a lower surface side of the blocking member, and the vacuum suction chuck having an inside diameter (φ2) greater at the upper end of the internal cavity than an inside diameter (φ1) at the lower end of the cavity.

The light-reflecting means (e.g., a mirror surface) and the increased reflecting surface area will further increase the amount of light reflected, and hence, synergistically enhance relative contrast with respect to the background. This will lead to even more definite discrimination of the work edge 122 from the chamfers 120 of the disk having the chamfered edge, and even more rapid disposition of the vacuum suction chuck at a predetermined position.

The work edge detection mechanism of the present invention enhances the contrast in luminance between the edge to be detected and the background, by reflecting with the light-reflecting means the light entering from the aligning camera, by increasing the amount of reflection of the light using the increased light-reflecting surface area, or by combining the two measures. As a result, the work edge is definitely discriminated from the chamfers of the work having the chamfered edge. This leads to rapid detection of the chamfered work edge, and hence, significant improvement of working efficiency in work edge detection and in subsequent successive operations.

In addition, through use of the vacuum suction chuck in the above-outlined work edge detection mechanism, the work transfer mechanism of the present invention detects clearly and within a short time the work edge to be vacuum-attracted, by image processing with the aligning camera, even without having another illumination device in the internal cavity of the vacuum suction chuck. Working efficiency associated with work transfer, therefore, improves significantly.

These features and advantages of the invention will be apparent from the following more particular description of preferred embodiments of the invention, as illustrated in the accompanying drawings.

### BRIEF DESCRIPTION OF THE DRAWINGS

FIG. 1 is a partial, schematic sectional view of an embodiment of a work edge detection mechanism according to the present invention;

FIG. 2A is a plan view showing a more specific example of a mirror surface of a work having a ring-shaped edge, the work being used in the work edge detection mechanism shown in FIG. 1;

FIG. 2B is a plan view showing a more specific example of a mirror surface of a work having a disc-shaped edge, the work being used in the work edge detection mechanism shown in FIG. 1;

FIG. 3 is a partial, schematic sectional view of another embodiment of a work edge detection mechanism according to the present invention;

FIG. 4 is a partial, schematic sectional view of yet another embodiment of a work edge detection mechanism according to the present invention;

FIG. 5 is a partial, schematic sectional view of an embodiment of a work transfer mechanism according to the present invention;

FIG. 6 is a partial, schematic sectional view of another embodiment of a work transfer mechanism according to the present invention;

FIG. 7 is a partial, schematic sectional view of yet another embodiment of a work transfer mechanism according to the present invention;

FIG. 8 is a partial, schematic sectional view of a further embodiment of a work transfer mechanism according to the present invention;

FIG. 9A is a bottom view of a vacuum suction chuck used in a work transfer mechanism according to the present invention, the chuck being provided with an annular continuous air suction hole on a suction surface of the chuck;

FIG. 9B is a bottom view of a vacuum suction chuck used in another work transfer mechanism according to the present invention, the chuck being provided with annular discontinuous air suction holes on a suction surface of the chuck;

FIG. 10 is a partial, schematic sectional view of the vacuum suction transfer mechanism used in a conventional technique;

FIG. 11 is a partially enlarged sectional view of the vacuum suction transfer mechanism shown in FIG. 10; and

FIG. 12 is a partial, schematic sectional view of an example of a mechanism for transferring a work in the conventional technique, the work having a chamfered edge.

### DESCRIPTION OF THE PREFERRED EMBODIMENTS

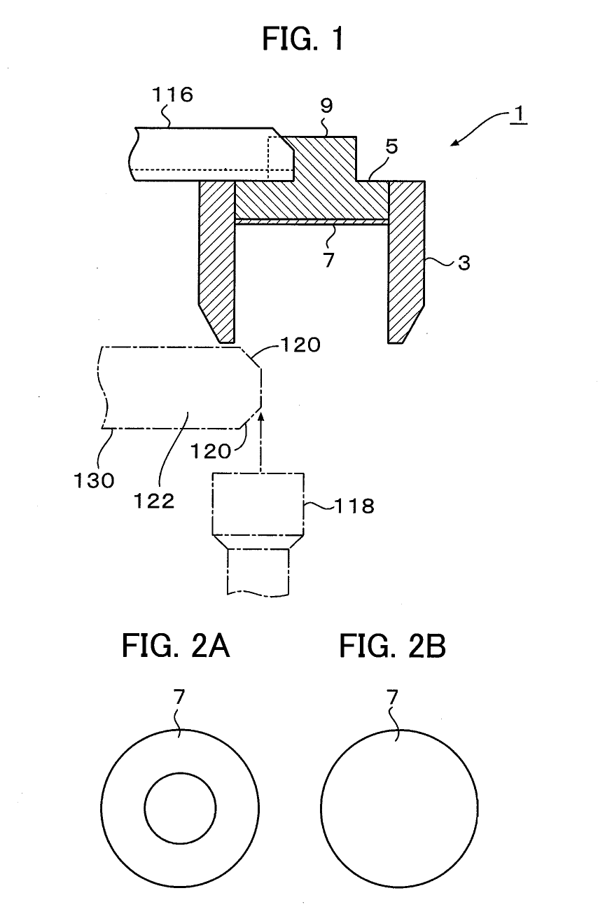

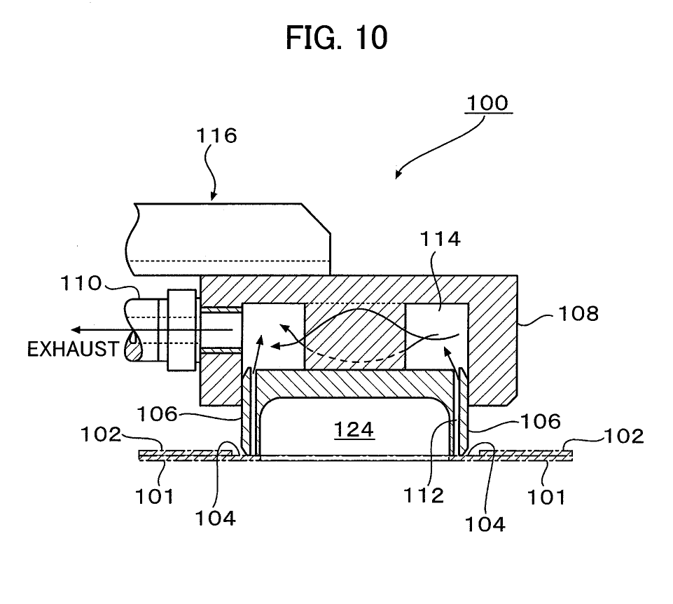

FIG. 1 is a partial, schematic sectional view of an embodiment of a work edge detection mechanism according to the present invention. The work edge detection mechanism 1 of the invention includes a tubular body 3 that is hollow inside. The tubular body 3 is opened at one end thereof and has a blocking member 5 at the other end. Light-reflecting means (e.g., a mirror surface) 7 for reflecting-any light entering from the opening exists on a lower surface side of the blocking member 5. The mirror surface 7 can be formed by, for example, working or finishing a lower surface of the blocking member 5 into a mirror surface. The mirror surface 7 can likewise be formed by, for example, providing the lower surface of the blocking member 5 with plating or any other chemical treatment or with buffing, polishing, or other mechanical processing. The blocking member 5 has a robot hand 116 engaged with an outward protrusion 9 to make the work edge detection mechanism 1 movable in XYZ directions. The robot hand 116 itself can be substantially the same as a conventional one shown by way of example in FIG. 10.

The mirror surface 7 reflects illumination light from an aligning camera 118 and enhances luminance contrast between a work edge 120 to be detected and a background. As a result, even without a special illumination device being disposed inside the work edge detection mechanism 1, the edge 120 can be detected reliably within a short time, such that working efficiency improves.

FIGS. 2A and 2B are plan views that show shapes of the mirror surface 7. The mirror surface 7 can be shaped into a ring form as shown in FIG. 2A, or into a disk or disc form as shown in FIG. 2B. Compared with the ring shape, the disk shape reflects a slightly great deal of light.

The mirror surface 7 can be either planar or convex. When the mirror surface 7 is convex, a greater amount of light reflection is anticipated since the illumination light from the aligning camera 118 is scattered.

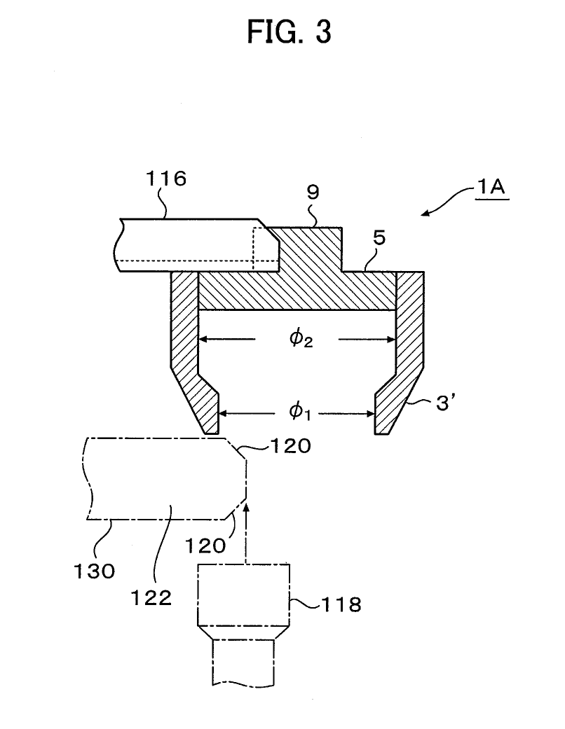

FIG. 3 is a partial, schematic sectional view of another embodiment of a work edge detection mechanism according to the present invention. The work edge detection mechanism 1A shown in FIG. 3 includes a tubular body 3′ whose inside diameter φ2 near a lower surface of a blocking member 5 is greater than an inside diameter φ1 of the tubular body at an opening thereof. Since the relationship of φ1<φ2 increases a light-reflecting area of the blocking member 5 relative to that obtainable when φ1=φ2, illumination light from the aligning camera 118 can be increased in the amount of reflection, with the result that the luminance contrast between the work edge 120 to be detected and the background can be enhanced. A preferable difference between φ1 and φ2 is 0.6 mm or more, and a further preferable difference between the two dimensions is 1.0 mm or more. When the difference between φ1 and φ2 is less than 0.6 mm, the blocking member 5 lacks an increase rate of a light-reflecting area at a lower surface thereof, for which reason, the luminance contrast between the work edge 120 to be detected and the background cannot be enhanced. A maximum allowable difference between φ1 and φ2 depends upon dimensions of the tubular body 3′. However, the maximum allowable difference is commonly around 4 mm.

Conversely, if the difference between φ1 and φ2 exceeds 4 mm, this saturates a luminance contrast augmentation effect and at the same time, increases the diameter of the tubular body 3′ too much. In addition, the work edge detection mechanism 1A itself becomes difficult to handle.

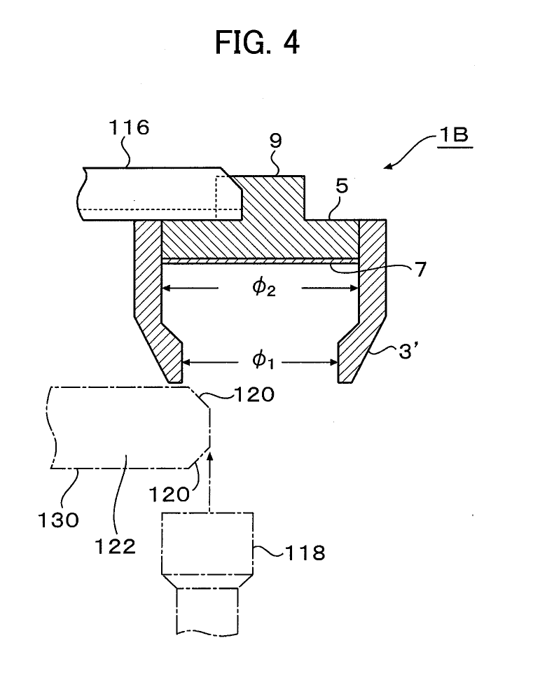

FIG. 4 is a partial, schematic sectional view of yet another embodiment of a work edge detection mechanism according to the present invention. The work edge detection mechanism 1B shown in FIG. 4 is characterized in that a mirror surface 7 exists on the lower surface side of the blocking member 5 and in that the inside diameter φ2 of the tubular body 3′, near the lower surface of the blocking member 5, is greater than the inside diameter φ1 of the tubular body at its opening. In the work edge detection mechanism 1B, a synergetic effect of an increase in the amount of light reflection by the mirror surface 7 shown in FIG. 1 and an increase in the amount of light reflection by the light-reflecting surface shown in FIGS. 2A and 2B develops an increase in luminance contrast.

The tubular bodies 3 and 3′ can have either a shape of a hollow cylindrical cone or a shape of a hollow prismatic cone. In addition, the tubular body 3 or 3′ and the blocking member 5, although shown separately in the embodiment, can be an integrated structure. In the illustrated embodiment, the tubular body 3 or 3′ and the blocking member 5 can be fixed to each other using known common means such as fitting-in, screwing/threading, bonding, or welding.

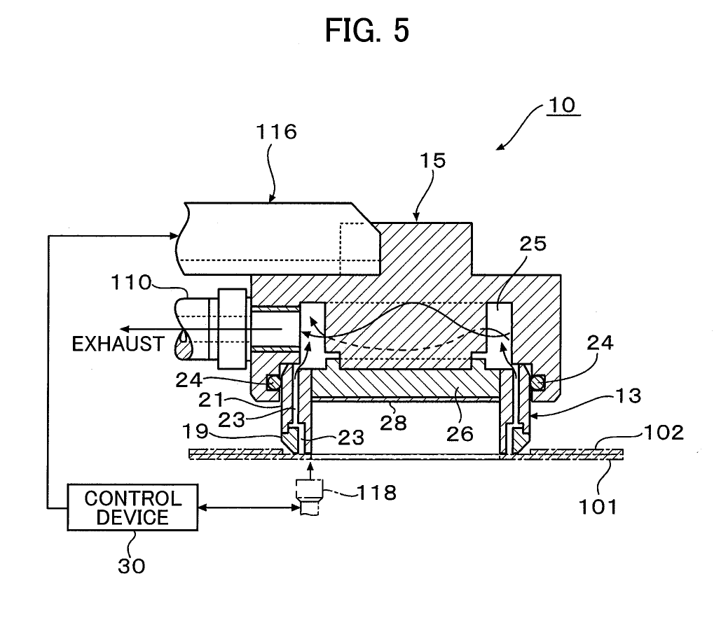

The work edge detection mechanism shown in either of FIGS. 1 to 4 can be applied to a mechanism for transferring a disk or other works by vacuum suction. FIG. 5 is a partial, schematic sectional view of an embodiment of a work transfer mechanism according to the present invention. The work transfer mechanism 10 shown in FIG. 5 basically includes a vacuum suction chuck 13, a vacuum suction head 15 coupled to the vacuum suction chuck 13, and a robot hand 116 connected to the head 15 in order to move the head 15 in XYZ directions. The vacuum suction chuck 13 is a hollow tubular element that includes a lower sidewall member 19 and an upper sidewall member 21, with an air suction hole(s) 23 being provided to extend through internal regions formed by the lower sidewall member 19 and upper sidewall member 21. An exhaust space 25 is provided inside the vacuum suction head 15, and each air suction hole 23 has an upper end opened towards the exhaust space 25. A suction pipe 110 is connected to one end of the exhaust space 25. The suction pipe 110 and the robot hand 116 itself can therefore be substantially the same as those used in the conventional vacuum suction transfer mechanism shown in FIG. 10. The air suction hole 23 has a lower end opened towards the atmosphere. Therefore, bringing the lower end of the air suction hole 23 into contact with a non-recording region 104 of a disk 101 makes the vacuum suction chuck 13 attract the disk 101 by vacuum suction.

A difference between the vacuum suction chuck 13 used in the work transfer mechanism 10 according to the present invention, and the vacuum chuck 106 used in the conventional vacuum suction transfer mechanism, is that in the vacuum suction chuck 13 of the present invention, a blocking member 26 is disposed on a side opposite to the opening in the hollow tubular chuck 13 and a mirror surface 28 for reflecting the light that has entered from the opening in the hollow tubular chuck 13 exists on a lower surface side of the blocking member 26. The mirror surface 28 reflects the illumination light coming in from the aligning camera 118, and enhances the luminance contrast between the work edge 120 to be detected and the background. Consequently, without a special illumination device placed inside the hollow tubular vacuum chuck 13, the edge 120 can be reliably detected within a short time and working efficiency improves significantly. Detection results by the aligning camera 118 are transmitted to the robot hand 116 via a control device 30, whereby operation of the robot hand 116 is controlled. The mirror surface 28 can be formed by, for example, working or finishing a lower surface of the blocking member 26 into a mirror surface. The mirror surface 28 can likewise be formed by, for example, providing the lower surface of the blocking member 5 with plating or any other chemical treatment or with buffing, polishing, or other mechanical processing.

The vacuum suction chuck 13 can be fixed to a bottom side of the vacuum suction head 15 by fitting-in, screwing/threading, bonding, welding, or other known common means. O-rings 24 are preferably arranged at contact interfaces between an outer wall of the upper sidewall member 21 and the vacuum suction head 15 in order to make the vacuum suction chuck 13 maintain a degree of vacuum with respect to the vacuum suction head 15.

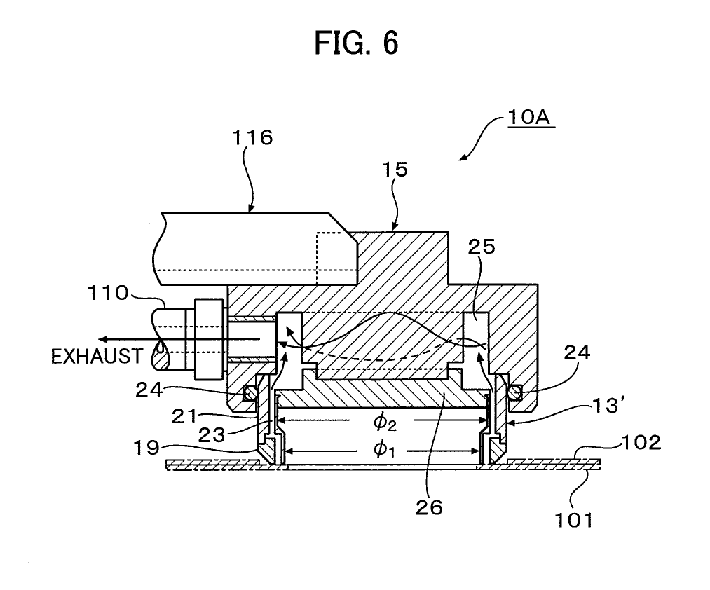

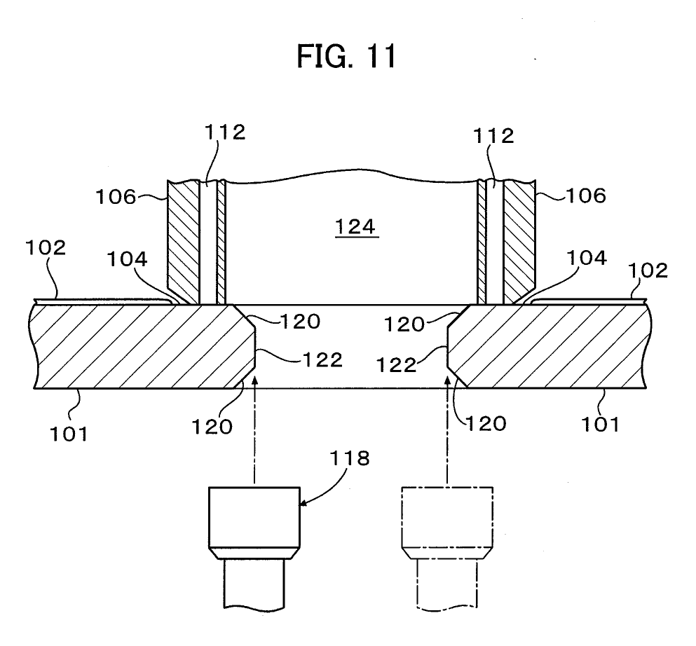

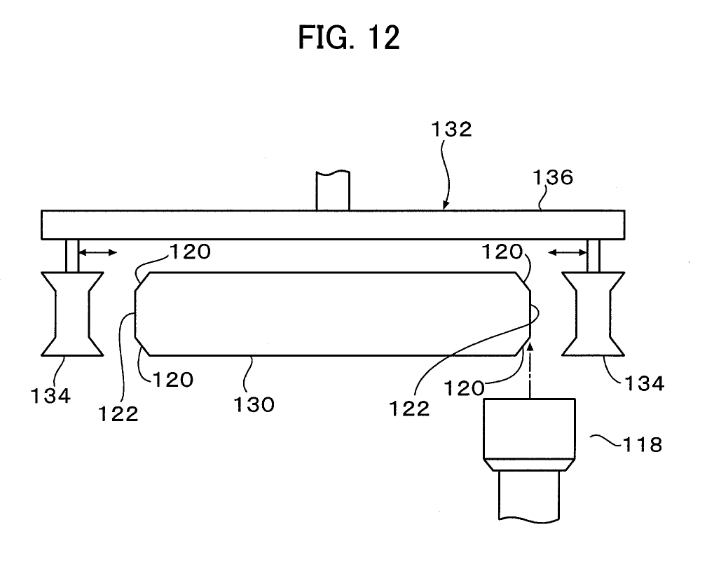

FIG. 6 is a partial, schematic sectional view of another embodiment of a work transfer mechanism according to the present invention. In the work transfer mechanism 10A of FIG. 6, unlike the work transfer mechanism 10 shown in FIG. 5, the mirror surface for reflecting the illumination light emitted from the aligning camera 118 is absent at the lower surface of the blocking member 26. In the work transfer mechanism 10A, the inside diameter of the internal cavity formed by the lower sidewall member 19 and the upper sidewall member 21 also differs between the lower and upper sections. In the vacuum suction chuck 13′ of the present invention, the inside diameter φ1 of the lower sidewall member 19 is smaller than the inside diameter φ2 of the upper sidewall member 21. That is to say, the vacuum suction chuck 13′ in the present invention always needs to have the relationship of φ1<φ2. Since the relationship of φ1<φ2 increases an area of the lower surface of the blocking member 26 relative to that obtainable if φ1=φ2, illumination light from the aligning camera 118 (see FIG. 11) can be increased in the amount of reflection. The vacuum suction chuck 13′ in the present invention is formed substantially from two parts (the lower sidewall member 19 and the upper sidewall member 21) to facilitate forming the relationship of φ1<φ2. Provided that the relationship of φ1<φ2 can be formed, however, the sidewall members can likewise be formed from one part only. A preferable difference between φ1 and φ2 is at least 0.6 mm, and a further preferable difference between the two dimensions is at least 1.0 mm. If the difference between φ1 and φ2 is less than 0.6 mm, the blocking member 26 lacks an increase rate of the area at the lower surface thereof, for which reason, the luminance contrast between the work edge 120 to be detected and the background cannot be enhanced. A maximum allowable difference between φ1 and φ2 depends upon dimensions of the vacuum suction chuck 13′. However, the maximum allowable difference is commonly around 4 mm. Conversely, if the difference between φ1 and φ2 exceeds 4 mm, this saturates a luminance contrast augmentation effect and at the same time, increases the diameter of the vacuum suction chuck 13′ too much. In addition, the work transfer mechanism 10A itself becomes difficult to be handled.

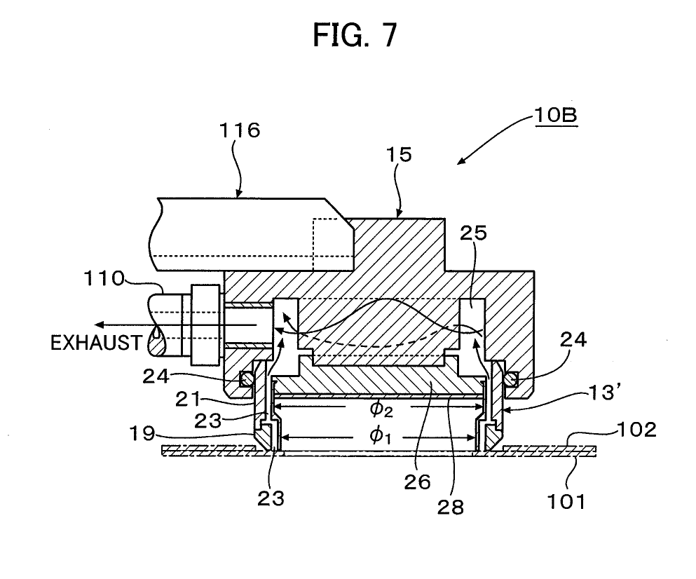

FIG. 7 is a partial, schematic sectional view of yet another embodiment of a work transfer mechanism according to the present invention. In the work transfer mechanism 10B of FIG. 7, the vacuum suction chuck 13′ whose inside diameter differs according to section as shown in FIG. 6 has a mirror surface 28 on the lower surface side of the blocking member 26 located in the chuck 13′. In addition to increasing the amount of light reflection by the mirror surface 28 shown in FIG. 7, the work transfer mechanism 10B increases the amount of light reflection by the large light-reflecting surface shown in FIG. 7. The synergetic effect of these increases makes the transfer mechanism develop an increase in luminance contrast.

The mirror surface 28, as with the mirror surface 7, can be shaped into a ring form as shown in FIG. 2A, or into a disk form as shown in FIG. 2B. Compared with the ring shape, the disk shape reflects a slightly great deal of light.

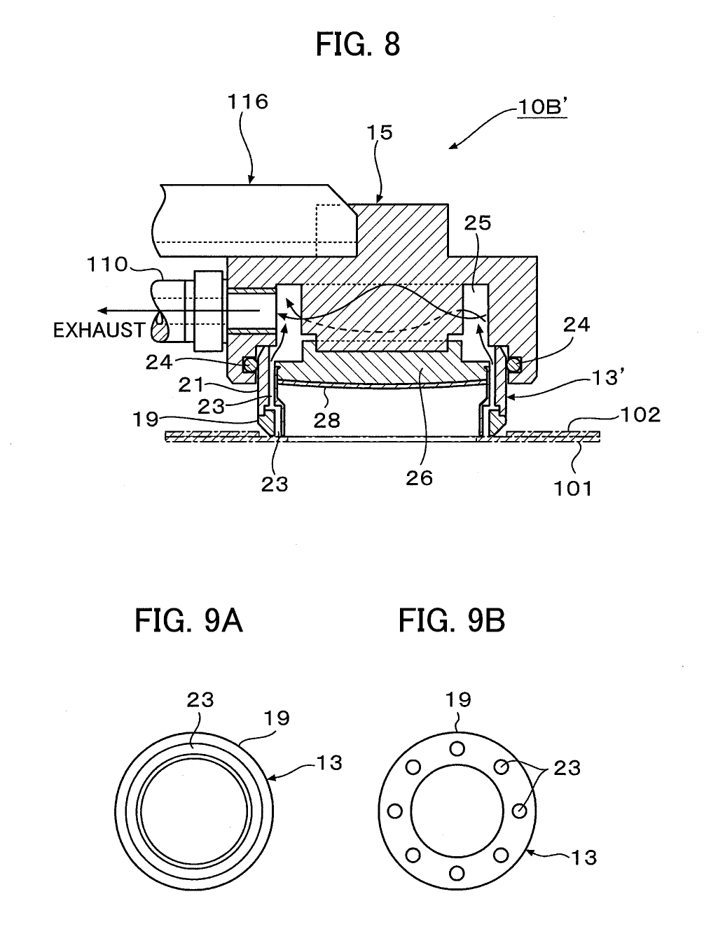

Further alternatively, the mirror surface 28 can be formed into a convex form as shown in FIG. 8. If the mirror surface 28 is formed into the convex form, a greater amount of light reflection is anticipated since the illumination light from the aligning camera 118 shown in FIG. 11 is scattered.

The blocking member 26 can be fixed to an inside-diametral side of the upper sidewall member 21 of the vacuum suction chuck 13 or 13′ by fitting-in, screwing/threading, bonding, welding, or other known common means. In FIGS. 5 to 8, the blocking member 26 is shown as an element separate from the sidewall members of the vacuum suction chuck 13′. Where desired, however, the blocking member 26 can instead be formed into a structure that resembles a tubular vessel integral with the sidewall members of the vacuum suction chuck 13 or 13′.

FIGS. 9A and 9B are bottom views of the vacuum suction chuck 13 or 13′ used in a work transfer mechanism of the present invention. The air suction holes 23 of the lower sidewall member 19, which are opened to a suction surface, can be of such a continuous annular shape as shown in FIG. 9A, or of such a discontinuous independent shape as shown in FIG. 9B.

### Example 1

An edge of a disc-shaped work measuring 1 mm in thickness and 64 mm in diameter and having a through-hole of a 24-mm inside diameter in a central region of the work was detected, and the work was transferred by suctioning the edge by vacuum. The through-hole has an edge chamfered as shown in FIG. 11. The conventional vacuum suction transfer mechanism (comparative example 1) shown in FIG. 10, the vacuum suction transfer mechanism (example 1-1) of the present invention, shown in FIG. 5, the vacuum suction transfer mechanism (example 1-2) of the invention, shown in FIG. 6, and the vacuum suction transfer mechanism (example 1-3) of the invention, shown in FIG. 7, were used for the vacuum suction transfer of the disc-shaped work. The inside diameter of the vacuum chuck 106 in the conventional vacuum suction transfer mechanism shown in FIG. 10 was 20.6 mm. The inside diameter (φ1) of the vacuum suction chuck 13 in the vacuum suction transfer mechanism of the invention, shown in FIG. 5, was 20.6 mm, and the inside diameter (φ1) of the lower sections of the vacuum suction chucks 13′ in the vacuum suction transfer mechanisms of the invention, shown in FIGS. 6 and 7, was 20.6 mm, and the inside diameter (φ2) of the upper sections of the vacuum suction chucks 13′ was 22.0 mm. The mirror surface 28 in the vacuum suction chuck 13 in the vacuum suction transfer mechanism of the invention, shown in FIG. 5, and the mirror surface 28 in the vacuum suction chuck 13′ in the vacuum suction transfer mechanism of the invention, shown in FIG. 7, were formed by polishing the lower surface of the blocking member 26. The Panasonic PV500 image checker employing a two-million-pixel CCD camera and an ×1.5 lens was used as an image-processing system for alignment. The image-processing system for alignment used LED-based coaxial episcopic illumination as an illumination light source.

The following lists 256-grayscale edge detection contrast differences in each transfer mechanism.

Comparative example 1: 2/256

### Example 1-1: 30/256

### Example 1-2: 25/256

### Example 1-3: 81/256

These measurement results indicate that, compared with the contrast difference of the comparative example, the contrast differences in the vacuum suction transfer mechanism (FIG. 5) of the present invention that used only a mirror surface as a reflecting region (example 1-1), and in the vacuum suction transfer mechanism (FIG. 6) of the invention that was only enlarged in inside diameter (example 1-2), are as great as at least 12 times, and thus that each of the latter two transfer mechanisms can independently detect the edge satisfactorily. The measurement results also indicate that the contrast difference of the vacuum suction transfer mechanism (FIG. 7) of the invention that used both a mirror surface and an enlarged inside diameter (example 1-3), is greater than a sum of the contrast differences of the above latter two transfer mechanisms (FIGS. 5 and 6) of the invention. It can therefore be confirmed that an advantageous effect by the combination of both is synergetic in comparison with those obtained from the independent use of each.

Edge detection accuracy by image processing was measured using the same vacuum suction transfer mechanisms as those described above. The following lists measurement results as average values of variations in pixel count at the same edge where image processing was repeated 100 times. Comparative example: Impossible to detect the edge by image processing.

Example 1-1: 5 pixels or less
Example 1-2: 5 pixels or less
Example 1-3: 2 pixels or less

These measurement results indicate that although the vacuum suction transfer mechanism as the comparative example was unable to detect the edge, the vacuum suction transfer mechanism (FIG. 5) of the present invention that used only a mirror surface as a reflecting region (example 1-1), and the vacuum suction transfer mechanism (FIG. 6) of the invention that was only enlarged in inside diameter (example 1-2) were able to detect the edge. In addition, the vacuum suction transfer mechanism (FIG. 7) of the invention, which used both a mirror surface and an enlarged inside diameter (example 1-3), improves in the edge detection accuracy by at least twice that of examples 1-1, 1-2.

While several preferred embodiments of the work edge detection mechanism and work transfer mechanism of the present invention have been described in detail and shown above, the invention is not limited to the embodiments described and shown in this specification. For example, the work transfer mechanism of the invention can use vacuum suction to transfer all works that require centering with an aligning camera prior to transfer, as well as disks having a hole in a central region thereof.

In addition, the mirror surface can be formed on an entire inner wall of the tubular member 3 and vacuum suction chuck 13′, as well as on the lower surface of the blocking member.

The invention may be embodied in other specific forms without departing from the spirit or essential characteristics thereof. The present embodiment is therefore to be considered in all respects as illustrative and not restrictive, the scope of the invention being indicated by the appended claims, rather than by the foregoing description, all changes that come within the meaning and range of equivalency of the claims are therefore intended to be embraced therein.

1. A work edge detection mechanism comprising:
a tubular body provided with an opening at one end thereof, the tubular body having a blocking member provided at the other end thereof; and
a light-reflecting means provided on a lower surface side of the blocking member for reflecting any light that enters from the opening.

2. The work edge detection mechanism according to claim 1, wherein the light-reflecting means has a mirror surface, the mirror surface having any one of shapes selected from the group consisting of a flat ring shape, a flat disk shape, and a convexly curved disk shape.

3. A work edge detection mechanism comprising:
a tubular body provided with an opening at one end thereof, the tubular body having a blocking member provided at the other end thereof;
wherein the tubular body has an inside diameter (φ1) at the opening of the tubular body and an inside diameter (φ2) at a side of the blocking member, the inside diameter (φ2) being greater than the inside diameter (φ1).

4. The work edge detection mechanism according to claim 3, wherein the difference between the inside diameters φ1 and φ2 ranges between 0.6 mm and 4.0 mm.

5. A work edge detection mechanism comprising:
a tubular body provided with an opening at one end thereof, the tubular body having a blocking member provided at the other end thereof; and
a light-reflecting means provided on a lower surface side of the blocking member for reflecting any light that enters from the opening;
wherein the tubular body has an inside diameter (φ1) at the opening of the tubular body and an inside diameter (φ2) at a side of the blocking member, the inside diameter (φ2) being greater than the inside diameter (φ1).

6. The work edge detection mechanism according to claim 5, wherein:
the light-reflecting means has a mirror surface, the mirror surface having any one of shapes selected from the group consisting of a flat ring shape, a flat disk shape, and a convexly curved disk shape;
the difference between the inside diameters φ1 and φ2 ranges between 0.6 mm and 4.0 mm.

7. A work transfer mechanism comprising:
a vacuum suction chuck;
a vacuum suction head coupled to the vacuum suction chuck;
a robot hand connected to the head in order to move the head in XYZ directions; and
a vacuum suction means coupled to the vacuum suction head to keep the vacuum suction chuck in vacuum pressure,
wherein, the vacuum suction chuck includes an annular sidewall and an internal cavity surrounded by the annular sidewall having a lower end and an upper end, and the sidewall internally has an air suction hole that extends from the lower end to the upper end, the lower end side of the air suction hole being opened towards the atmosphere and the upper end side of the air suction hole being opened towards an internal exhaust space of the vacuum suction head, the vacuum suction chuck further includes a blocking member which is disposed at an upper end of the cavity and a light-reflecting means which is disposed on a lower surface side of the blocking member.

8. The work transfer mechanism according to claim 7, wherein the light-reflecting means has a mirror surface, the mirror surface having any one of shapes selected from the group consisting of a flat ring shape, a flat disk shape, and a convexly curved disk shape.

9. A work transfer mechanism comprising:
a vacuum suction chuck;
a vacuum suction head coupled to the vacuum suction chuck;
a robot hand connected to the head in order to move the head in XYZ directions; and
a vacuum suction means coupled to the vacuum suction head to keep the vacuum suction chuck in vacuum pressure,
wherein, the vacuum suction chuck includes an annular sidewall which surrounds a cavity, the annular sidewall internally has an air suction hole that extends from a lower end to an upper end of the annular sidewall, the lower end of the air suction hole being opened towards the atmosphere and the upper end of the air suction hole being opened towards an internal exhaust space of the vacuum suction head, the vacuum suction chuck further includes a blocking member which is disposed at an upper end of the cavity, and an inside diameter (φ2) of the upper end of the cavity is greater than an inside diameter (φ1) of the lower end thereof.

10. The work transfer mechanism according to claim 9, wherein the difference between the inside diameters φ1 and Φ2 ranges between 0.6 mm and 4.0 mm.

11. A work transfer mechanism comprising:
a vacuum suction chuck;
a vacuum suction head coupled to the vacuum suction chuck;
a robot hand connected to the head in order to move the head in XYZ directions; and
a vacuum suction means coupled to the vacuum suction head to keep the vacuum suction chuck in vacuum pressure,
wherein the vacuum suction chuck includes an annular sidewall which surrounds a cavity, the annular sidewall internally has an air suction hole that extends from a lower end to an upper end of the annular sidewall, the lower end of the air suction hole being opened towards the atmosphere and the upper end of the air suction hole being opened towards an internal exhaust space of the vacuum suction head, the vacuum suction chuck further includes a blocking member which is disposed at an upper end of the cavity and a light-reflecting means which is disposed on a lower surface side of the blocking member,
wherein an inside diameter (φ2) of the upper end of the cavity is greater than an inside diameter (φ1) of the lower end thereof.

12. The work transfer mechanism according to claim 11, wherein:
the light-reflecting means has a mirror surface, the mirror surface having any one of shapes selected from the group consisting of a flat ring shape, a flat disk shape, and a convexly curved disk shape; and
the difference between the inside diameters φ1 and φ2 ranges between 0.6 mm and 4.0 mm.
